(19) United States
(12) Patent Application Publication
(10) Pub. No.: US 2008/0066588 A1
(43) Pub. Date: Mar. 20, 2008

(54) Locking pliers with a locking lever between handles

(76) Inventor: Ching-Chen Yang, Taiping City (TW)

Correspondence Address: PRO-TECHTOR INTERNATIONAL SERVICES, 20775 NORADA CT., SARATOGA, CA, 95070, US

(21) Appl. No.: 11/521,798

(22) Filed: Sep. 15, 2006

(51) Int. Cl. B25B 7/14

(52) U.S. Cl. 81/318; 81/320; 81/323

(57) ABSTRACT

A pair of locking pliers includes a first handle having a holed wall; a second handle pivotably secured to the first handle; a multi-sided link pivotably secured to a jaw of the second handle and including a shank passed through the wall; an L-shaped lever pivotably secured to the first handle and including a first portion disposed rearward of the wall, a projected second portion between the handles, and a multi sided aperture through the first portion with a rear end of the link passed through; and a spring put on the link and biased between the wall and the first portion. The link is locked in the aperture by disposing the first portion obliquely about the link. Pivoting the lever will compress the spring, unlock the pliers by disposing the link perpendicularly to the first portion, and pivotably push the first and second handles away from each other.

### BACKGROUND OF THE INVENTION

1. Field of Invention

The invention relates to gripping tools and more particularly to a pair of locking pliers having a locking lever disposed between handles.

2. Related Art

A pair of conventional locking pliers is shown in FIG. 6 and comprises a first handle 5 having a first jaw (not numbered); a second handle 6 pivotably secured to the first handle 5 by means of a pivot joint and having a second jaw 61; a substantially L-shaped lever 1 outwardly projected from a portion of the first handle 5 proximate the pivot joint, the lever 1 including a concealed end 11 within the first handle 5, a bending portion 12 provided externally of the first handle 5, a pivot 13 within the first handle 5, and a lengthwise channel 14 in the first handle 5; a shallow cavity 21 in the first handle 5 and provided between the pivot joint and the lever 1; a ring 2 provided in the cavity 21; a link 3 having a point 31 pivotably secured to the second jaw 61 and a shank portion provided through the ring 2, the channel 14, and an internal tunnel (not shown) of the first handle 5; and a helical spring 4 biased between the ring 2 and the pivot 13.

But this is unsatisfactory for the purpose for which the present invention is concerned for the following reasons: Firstly, the outwardly projected lever 1 is visually unattractive and detracts from the appearance of the pliers. Secondly, the outwardly projected lever 1 may hinder the clamping operation by the hand. Thirdly, the channel 14 is required to line up with the shank of the link 3 in assembly. This involves a high precision operation and may result in an increase in the manufacturing cost. Thus, the need for improvement still exists.

### SUMMARY OF THE INVENTION

It is therefore an object of the present invention to provide a pair of locking pliers having the following advantages. Firstly, its projected lever is disposed between first and second handles. Thus, it is aesthetic. Secondly, the projected lever does not hinder the clamping operation by the hand. Thirdly, its assembly is relatively simple, resulting in a decrease in the manufacturing cost. Fourthly, an unlocking operation of the pliers is quick and smooth.

To achieve the above and other objects, the present invention provides a pair of locking pliers comprising a first handle including a first jaw, a rear wall having a first aperture, and a yoke in a rear of the rear wall; a second handle including a second jaw and pivotably secured to the first handle by means of a spring biased pin; a multi-sided link pivotably secured to the second jaw and including a shank passed through the first aperture to terminate at a position between the yoke; a substantially L-shaped lever pivotably secured to the yoke and including a first portion disposed rearward of the rear wall, a second portion disposed externally of the first handle and between the first and second handles, and a multi sided second aperture through the first portion of the lever with a rear end of the link passed through; and a spring put on a rear portion of the link and biased between the rear wall and the first portion of the lever; wherein in a locked position of the pliers the link is locked in the second aperture by disposing the first portion of the lever obliquely relative to the rear end of the link; and whereby pivoting the lever about the first handle by pressing the second portion of the lever will compress the spring, unlock the pliers by disposing the link to be perpendicular to the first portion of the lever, and pivotably push ends of the first and second handles further away from each other.

The above and other objects, features and advantages of the present invention will become apparent from the following detailed description taken with the accompanying drawings.

### BRIEF DESCRIPTION OF THE DRAWINGS

FIG. 1 is a perspective view of a preferred embodiment of a pair of locking pliers according to the present invention in its open position;

FIG. 2 is an exploded view of the pliers;

FIG. 3 is a schematic perspective view of the pliers in its closed position;

FIG. 4 is a view similar to FIG. 3 where portions are shown in section for illustrating the lever to be pivotably moved toward the first handle by pressing;

FIG. 5 is a view similar to FIG. 3 where the pliers is open after pressing the lever; and

FIG. 6 is a perspective view in part section of a pair of conventional locking pliers in its open position.

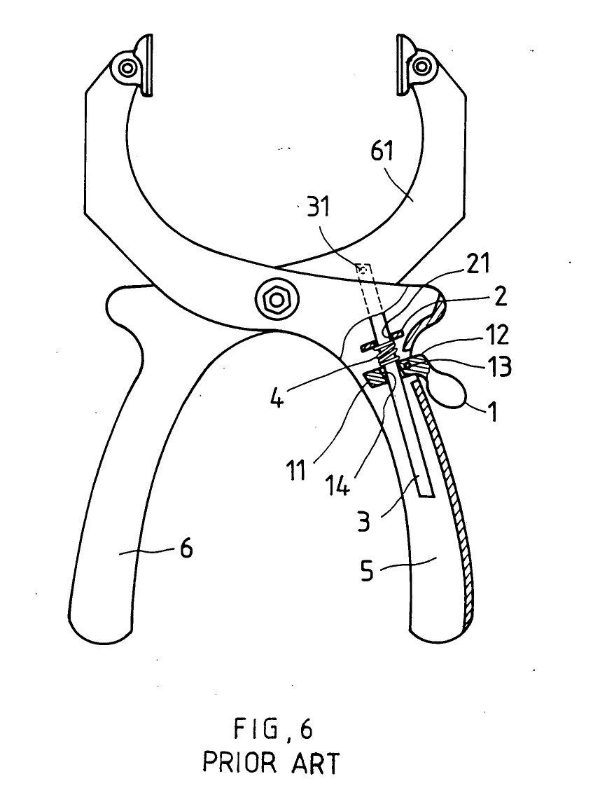

### DETAILED DESCRIPTION OF THE INVENTION

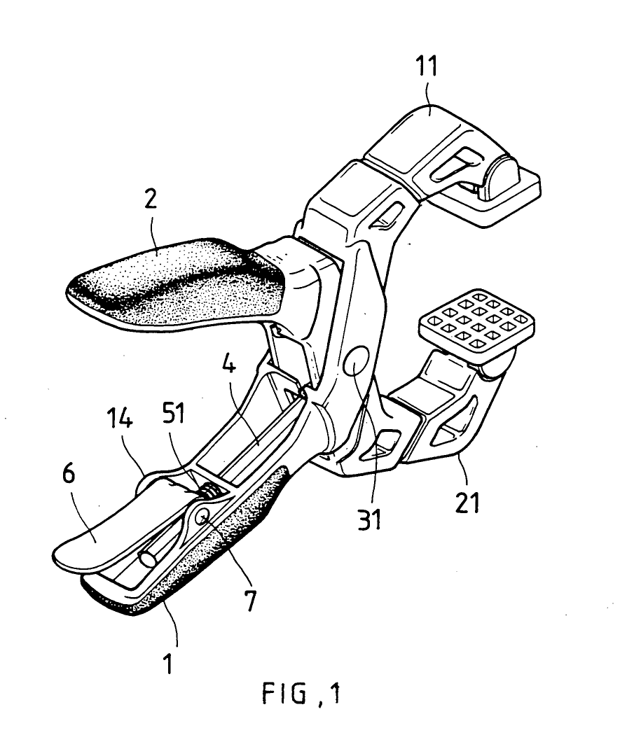

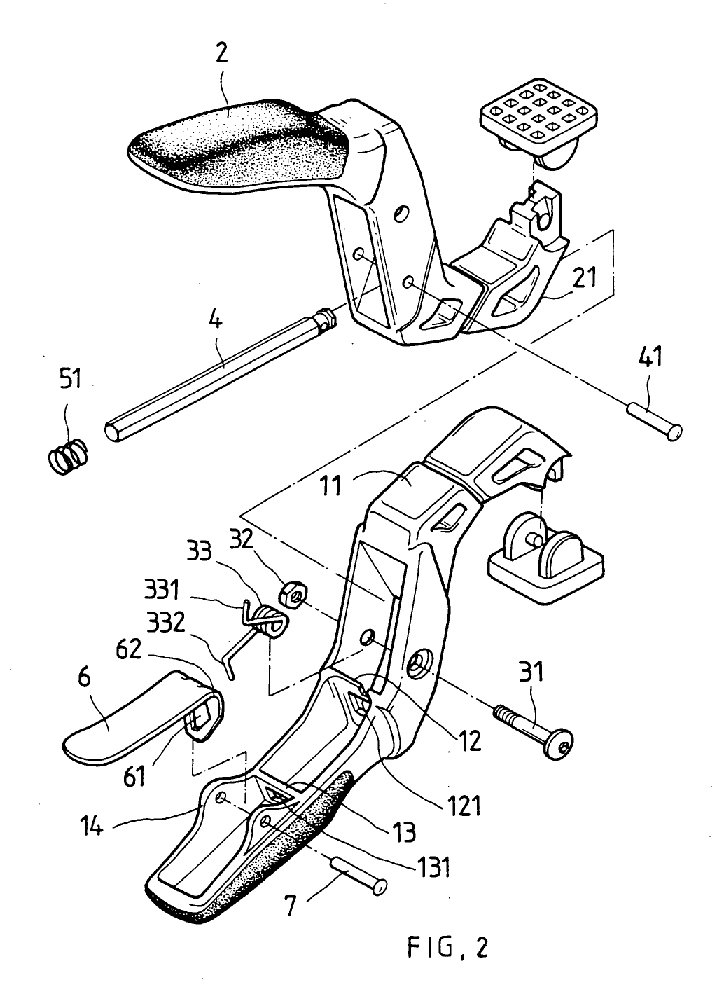

Referring to FIGS. 1 to 5, a pair of locking pliers in accordance with a preferred embodiment of the present invention is shown. The pliers comprises a first handle 1 including a first jaw 11, a forward wall 12 having a rectangular aperture 121, a rear wall 13 having a rectangular aperture 131, and two opposite yoke members 14 in the rear of the rear wall 13; a second handle 2 pivotably secured to the first handle 1 by means of a pin 31 passed the first handle 1, a nut 32 secured to an end of the pin 31, and a torsion spring 33 put on the shank of the pin 31 and having one end 331 urged against a forward wall (not numbered) of the second handle 2 and the other end 332 urged against the forward wall 12, the second handle 2 having a second jaw 21; an elongate, multi-sided link 4 having one end pivotably secured to the second jaw 21 and a shank portion passed through the apertures 121 and 131 to terminate at a position between the yoke members 14; a helical spring 51 put on a rear portion of the link 4; a substantially L-shaped lever 6 including a curved bending point 62, one short portion 63 disposed in a rear space of the first handle 1, and a multi sided aperture 61 through one portion 63 with a rear end of the link 4 passed through; and a pin 7 passed through the apertures of the yoke members 14 and engaged with an inner face of the bending point 62 of the lever 6.

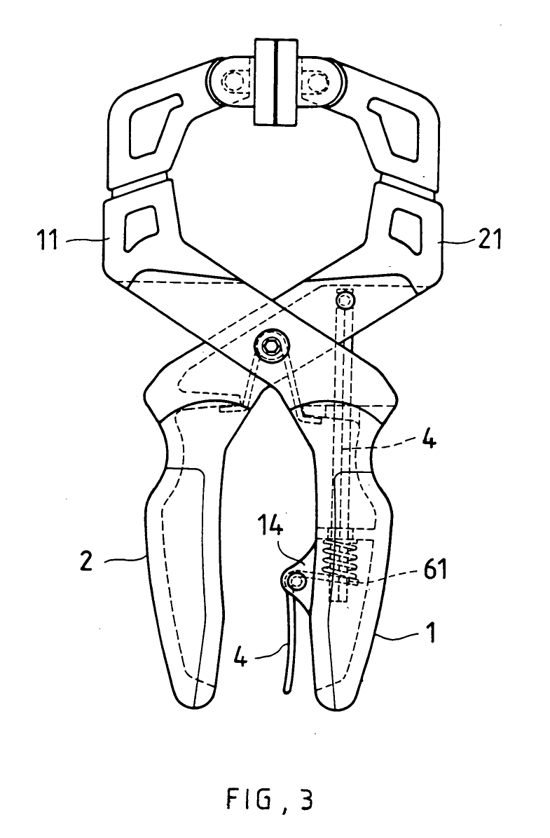

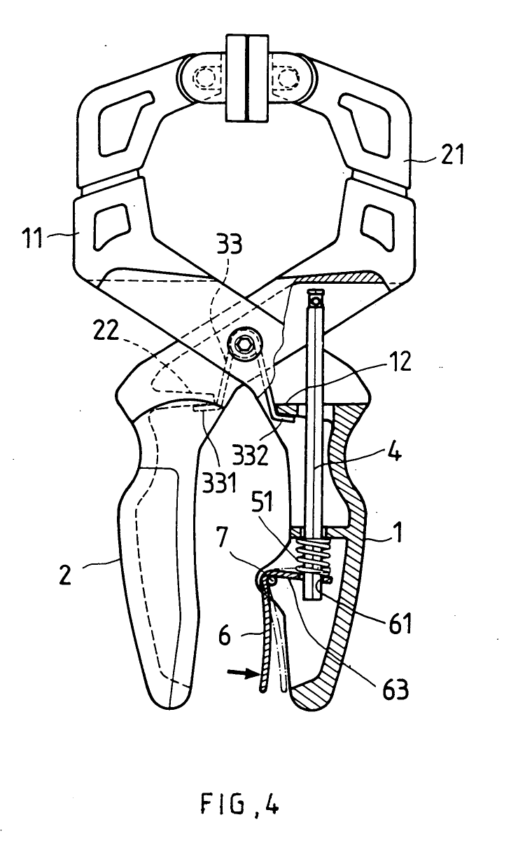

By configuring as above, the spring 51 has both ends urged against one portion 63 of the lever 6 and the rear wall 13, the lever 6 is made pivotal with respect to the yoke members 14 (i.e., the first handle 1), and the rear end of link 4 is locked by the aperture 61 (i.e., the pliers is locked) because one portion 63 is disposed obliquely relative to the rear end of the link 4 as shown in FIGS. 3 and 4.

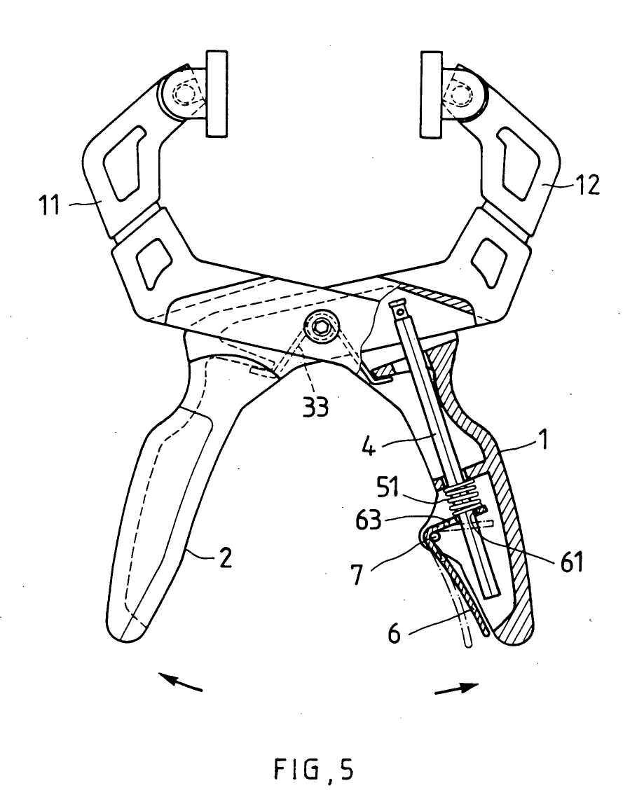

For unlocking the pliers, a user may press the lever 6 toward the first handle 1 to pivot one portion 63 about the pivot joint of the yoke members 14 with the spring 51 being compressed until the link 4 is perpendicular to one portion 63 (see FIG. 4). Once the pliers is unlocked, the spring 33 releases its stored elastic energy to pivotably push the first and second handles 1 and 2 further away from each other (see FIG. 5).

In view of the above, the present invention thus has the following advantages. Firstly, the projected lever 1 is disposed between the first and second handles 1 and 2. Thus, it is aesthetic. Secondly, the projected lever 1 does not hinder the clamping operation by the hand. Thirdly, its assembly is relatively simple, resulting in a decrease in the manufacturing cost. Fourthly, the unlocking operation of the pliers is quick and smooth due to the unique features of the springs 33 and 51.

It is to be understood that the present invention is by no means limited only to the particular constructions herein disclosed and shown in the drawings, but also comprises any modifications or equivalents within the scope of the claims.

1. (canceled)

2. A pair of locking pliers comprising:
a first member comprising a proximal handle portion having a first wall in a proximal end portion thereof, with an aperture in the first wall, a yoke on the handle portion near the first wall, and a distal jaw portion;
a second member comprising a proximal handle portion and a distal jaw portion, the second member being positioned crossing the first member with the respective jaw portions opposing, and pivotably secured to the first member at an intermediate point between the jaw portion and the handle portion;
a link mechanism with a distal end pivotably secured to the jaw portion of the second member and a proximal end portion releaseably secured to the proximal handle portion of the first member, and including
a shank with a distal end pivotably secured to the jaw portion of the second member, and a proximal end passed through the aperture in the first wall of the handle portion of the first member, to terminate at a position proximal to said first wall,
a substantially L-shaped release lever pivotably secured to the yoke and including a first portion disposed proximally of the first wall, a second portion disposed externally of the handle portion of the first member and between the handle portions of the first and second members, and having a second aperture through the first portion of the lever with a proximal end of the shank passed through, and perpendicular to the first portion of the lever, and pivotably push the handle portions of the first and second members further away from each other.
a spring biased between the rear wall and the first portion of the lever;
wherein in a locked position of the pliers the link is locked in the second aperture by disposing the first portion of the lever obliquely relative to the proximal end of the link; and whereby pressing the second portion of the lever will compress the spring, unlocking the pliers by disposing the link to be perpendicular to the first portion of the lever, and pivotably push the handle portions of the first and second members further away from each other.

3. The pair of locking pliers of claim 1, wherein the shank of the link mechanism, and the first and second apertures are each multi-sided.

4. The pair of locking pliers of claim 1, wherein the handle portion of the first member further comprises a distal wall with a third aperture.
